(19) United States
(12) Patent Application Publication
(10) Pub. No.: US 2002/0015937 A1
(43) Pub. Date: Feb. 7, 2002

(54) Methods for inactivating viruses

(76) Inventors: Thomas M. Setcavage, Milford, NJ (US); Kenneth Denich, Edmonton (CA)

Correspondence Address: BELL, BOYD & LLOYD LLC, P.O. Box 1135, Chicago, IL, 60690-1135, US

(21) Appl. No.: 09/774,294

(22) Filed: Jan. 29, 2001

Related U.S. Application Data
(60) Provisional application No. 60/179,230, filed on Jan. 31, 2000.

(51) Int. Cl. A01N 1/02

(52) U.S. Cl. 435/2

(57) ABSTRACT

The present invention is for improved methods of inactivating viruses in a sample by exposing the sample to a combination of pressure treatment and exposure to an inactivating agent. The sample can be repeatedly cycled between relatively high and low pressures and the inactivating agent is selected from ethyleneimine, ethyleneimine oligomers, psoralens, DNase and RNase.

This patent application is directly related to U.S. Provisional Patent Application 60/179,230, filed Jan. 31, 2000, the entire contents of which are hereby incorporated by reference and relied upon.

### BACKGROUND OF THE INVENTION

1. Field of the Invention

The present invention discloses improved methods for inactivating viruses. The methods comprise exposing a sample containing a virus to a combination of pressure treatment and exposure to an inactivating agent. The sample can be repeatedly cycled between relatively high and low pressures and the inactivating agent is selected from ethyleneimine, ethyleneimine oligomers, psoralens, DNase and RNase.

2. Description of the Related Art

A necessity exists for a system that can ensure the safety of blood plasma and blood plasma derivatives by inactivating and sterilizing pathogens since no commercially available process currently exists to optimally meet this critical need. The safety of the world's blood supply is of major concern with respect to transmissible viruses and undetectable infectious particles. In addition, the emergence of unknown viruses and infectious particles, such as prions underline the need for a new, simple, fast-acting, and safe method of sterilization of blood and blood products.

Each virus has either RNA or DNA as its genetic material. The nucleic acid, which may be either single-stranded or double-stranded, is contained within a protein layer. The coat or capsid that encloses the nucleic acid is composed of one or more proteins that are specific to each kind of virus. The capsid plus the enclosed nucleic acid is called the nucleocapsid. In some viruses, an external envelope consisting of lipids and proteins surrounds the nucleocapsid.

Examples of viruses include the non-enveloped viruses, including human parvovirus B19 (B19), hepatitis A virus (HAV), vaccinia, and SV40 viruses and enveloped viruses such as human immunodeficiency virus (HIV-1), herpes simplex virus (HSV-1), hepatitis B virus (HBV) and hepatitis C virus (HCV).

Pressure is known to inactivate viruses. For example, WO 00/48641 (Laugharn et al.) discloses methods for inactivating lambda bacteriophage, Moloney Murine Leukemia Virus, porcine parvovirus, Human Immunodeficiency Virus (HIV-1) and Herpes Simplex Virus (HSV-1) in biological samples by repeatedly cycling the samples between relatively high and low pressures.

Ethyleneimine monomers have been used to inactivate the foot-and-mouth disease virus (Russian Patent SU 1915956). Ethyleneimine monomers have also been used to inactivate Mycoplasma and Acholeplasma (WO 92/18161) and avian infections (Romanian Patent RO 101400). Binary ethyleneimine has been used to inactivate feline enteric coronavirus, FFECV (European Patent EP 94200383). Polyethyleneimine has been used as a plant virus control agent (Japanese Patent JP 7882735). Budowsky et al., Vaccine Research, Vol. 5 (1): 29-39, 1996 and Budowsky (WO 97/07674) have reported that bacteriophage MS2 and Venezuelan Equine Encephalitis virus were successfully inactivated by exposure to ethyleneimine oligomers.

Furocoumarins, such as psoralens, in the presence of ultraviolet light have been used to inactivate viruses. Psoralens are tricyclic compounds formed by the linear fusion of a furan ring with a coumarin. Psoralens can intercalate between the base pairs of double-stranded nucleic acids, forming covalent adducts to pyrimidine bases upon absorption of long wave ultraviolet light (UVA). Cimino et al., Ann. Rev. Biochem., 54: 1151, 1985; Hearst et al., Quart. Rev. Biophys., 17: 1, 1984. If there is a second pyrimidine adjacent to a psoralen-pyrimidine monoadduct and on the opposite strand, absorption of a second photon can lead to formation of a diadduct which functions as an interstrand crosslink. Isaacs et al., Biochem., 16: 1058, 1977; Tessman et al., Biochem., 24: 1669, 1985; U.S. Pat. No. 4,124,598 (Hearst et al.); U.S. Pat. No. 4,169,204 (Hearst et al.); and U.S. Pat. No. 4,196,281 (Hearst et al.).

The covalently bonded psoralens act as inhibitors of DNA replication and thus have the potential to stop the replication process. Due to this DNA binding capability, psoralens are of particular interest in relation to solving the problems inherent in creating and maintaining a pathogen-free blood supply. Some known psoralens have been shown to inactivate viruses in some blood products. U.S. Pat. No. 4,727,027 (Wiesehahn et al.) and U.S. Pat. No. 4,748,120 (Wiesehahn et al.) disclose the use of a combination of 8-methoxypsoralen (8-MOP) and irradiation to inactivate viruses in blood. WO 96/40857 (Hei) discloses methods and devices for the removal of psoralens and psoralen photoproducts from blood products.

In addition, nucleases are enzymes known to break down nucleic acids, including viral RNA and DNA. More specifically, deoxyribonuclease (DNase) and ribonuclease (RNase) are enzymes that hydrolyze DNA and RNA, respectively.

Therefore, it is the objective of the present invention to develop an improved method for inactivating viruses to better ensure the safety of blood plasma and blood plasma derivatives.

### SUMMARY OF THE INVENTION

The present invention discloses methods of inactivating viruses in a sample. A first method comprises the steps of adding an inactivating chemical to the sample; exposing the sample to an elevated pressure; releasing the pressure; and recovering the sample.

In a preferred embodiment of the first method, the inactivating chemical is selected from the group consisting of ethyleneimine, ethyleneimine oligomers, DNase and RNase. In another preferred embodiment, the sample is human blood plasma. In yet another preferred embodiment, the elevated pressure is in the range of about 5,000 psi to about 150,000 psi.

A second method of inactivating viruses in a sample comprises the steps of adding an inactivating chemical to the sample; exposing the sample to an elevated pressure; releasing the pressure; irradiating the sample with UV light; and recovering the sample.

In a preferred embodiment of the second method, the inactivating chemical is a psoralen. In another preferred embodiment, the sample is selected from human blood plasma, human plasma derivatives and recombinant human blood plasma derivatives. In yet other preferred embodiments, the elevated pressure is in the range of about 5,000 psi to about 150,000 psi and UV irradiation time is from 1 minute to 300 minutes.

A third method of inactivating viruses in a sample comprises the steps of adding an inactivating chemical to the sample; exposing the sample to an elevated pressure; releasing the pressure; re-exposing the sample to an elevated pressure; releasing the pressure; and recovering the sample.

In a preferred embodiment, the inactivating chemical is selected from the group consisting of ethyleneimine, ethyleneimine oligomers, DNase and RNA. In another preferred embodiment, the sample is selected from human blood plasma, human blood plasma derivatives and recombinant human blood plasma derivatives. In other preferred embodiment, the pressure is in the range of about 5,000 psi to about 150,000 psi and the sample is pressure recycled between 2 and 1000 times.

A fourth method of inactivating viruses in a sample comprises adding an inactivating chemical to the sample; exposing the sample to an elevated pressure; releasing the pressure; re-exposing the sample to an elevated pressure; releasing the pressure; irradiating the sample with UV light; and recovering the sample.

In a preferred embodiment, the inactivating chemical is a psoralen. In another preferred embodiment, the sample is selected from human blood plasma, human blood plasma derivatives and recombinant human blood plasma derivatives. In other preferred embodiments, the pressure is in the range of about 5,000 psi to about 150,000 psi and the sample is pressure recycled between 2 and 1000 times. In yet another preferred embodiment the UV irradiation time is from 1 minute to 300 minutes.

### DETAILED DESCRIPTION

A variety of chemicals and chemical treatments, e.g., ethyleneimine and ethyleneimine oligomers, psoralens and UV light treatment and nucleases can be used to inactivate viruses or to degrade viral nucleic acids. The use of such chemicals can have negative effects, however, including slow inactivation, potential for protein damage, or the inability of compounds to penetrate to the interior of the virus. Elevated pressure can enhance the inactivation activity of these chemicals without exacerbating the negative effects. For example, elevated pressure can increase the chemicals' effectiveness against heat stable non-encapsulated viruses such as parvovirus and hepatitis A virus.

The present invention is for improved methods of inactivating viruses in a sample by exposing the sample to a combination of pressure treatment and exposure to an inactivating agent. The sample can be repeatedly cycled between relatively high and low pressures and the inactivating agent is selected from ethyleneimine, ethyleneimine oligomers, psoralens, DNase, RNase and other viral-inactivating compounds. The sample is preferably human blood plasma; human blood plasma derivatives, for example, factors VII, VIII, IX, XI, XIII, antithrombin III, protein C, C₁-inhibitor, alpha-1-antitrypsin, fibrin sealant, etc; and recombinant human blood plasma derivatives.

### Pressure and Pressure Cycling

Pressure inactivation of viruses can be achieved by providing a sample at an initial pressure, e.g., 1 atm, and temperature, e.g., 25° C., lower temperature such as 0° C., -5° C., -25° C., -40° C. or lower; increasing the pressure to an elevated pressure sufficient to inactivate at least some, e.g., 10%, 25%, 50%, 75%, 90%, 95%, 99%, or even substantially all, viruses contained in the sample, e.g., in the range of about 5,000 psi to about 95,000 psi, or in the range of about 10,000 psi to about 75,000 psi, or in the range of about 95,000 psi to about 150,000 psi; and subsequently decreasing the pressure to a reduced pressure, which may be about the same as, less than, or greater than the initial pressure, e.g., 1 atm, to provide a sterilized sample, i.e., a sample having a reduced titer of viruses.

The pressure can optionally be repeatedly cycled, e.g., 2, 3, 5, 10, 100, 1000, or 10000 or more times, between the elevated pressure and the initial pressure. Each pressure cycle includes the steps of increasing the pressure to an elevated pressure, e.g., between about 10,000 psi and 120,000 psi, between about 40,000 psi and about 100,000 psi, or between about 70,000 psi and about 90,000 psi; maintaining an elevated pressure for a time period tₑ; decreasing the pressure to a reduced pressure; and maintaining the sample at a reduced pressure, e.g., a pressure less than the elevated pressure, and less than, equal to, or greater than the initial pressure, for a period of time tᵢ. The elevated pressure is sufficient such that each cycle inactivates at least some, e.g., at least 1%, 5%, 10%, 25%, 50% or more, of the viruses in the sample when the elevated pressure is maintained for time tₑ, e.g., between about 0.5 seconds and 300 minutes, preferably between about 5 or 10 and about 30 minutes.

Such cycling can be carried out at the initial temperature, at a low temperature, e.g., subzero temperatures such as between −40° C. and 0° C., or between -20° C. and -5° C., or while the material is being cooled to a low temperature. The timing of the cycles may be such that the temperature of the material is allowed to equilibrate, e.g., to the temperature of the walls of the reaction vessel in which the method is carried out, prior to each cycle.

### Ethyleneimine

An “ethyleneimine oligomer” according to this invention refers to oligimers of ethyleneimine having a terminal aziridino group and optionally substituted. Preferred ethyleneimine oligomers of this invention have at least two ethyleneimine units and include, for example, the dimer, the trimer or the tetramer, either linear or branched. Synthesis of the ethyleneimine oligomers of this invention is performed using synthetic schemes well known in the art. See, for example, Kostyanovsky, R.G. et al. (Translated from Izvestiya Akademii Nauk SSSR, Seriya Khimicheskaya, Vol.11: 2566-2577, 1988). In the methods of this invention, ethyleneimine oligomers of less than ten units are preferable and ethyleneimine oligomers of about two, three or four units are more preferable.

Ethyleneimine oligomers can also be substituted so long as this does not eliminate the essential property of the ethyleneimine. In one embodiment, the ethyleneimine oligomers are substituted with halogens and have the general formula β-Hal-(CH₂—CH₂—NH)ₙH, where Hal is a halogen. Such compounds, often referred to as nitrogen mustards, are synthesized by the quantitative conversion by hydrogen chloride or hydrogen bromide of ethyleneimine or its oligomers into β-halogenomono- or oligo-ethylamines. The nitrogen mustards are strong electrophiles and alkylate nucleophilic groups of nucleic bases either directly or through intermediate conversion into the respective aziridines. As ethyleneimine oligomers, the βhalogeno-oligo-ethylamines have a high affinity for polyanions. Therefore, these ethyleneimine oligomers have a high selectivity for nucleic acids.

Representative ethyleneimine oligomers are disclosed in Table 1.

TABLE 1
Ethyleneimine and Representative Ethyleneimine Oligomers
Monomer
aziridine (ethyleneimine)

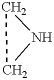

Dimers
1-(2-aminoethyl)aziridine

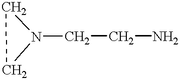

1-(2-hydroxyethyl)aziridine

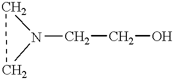

Trimer

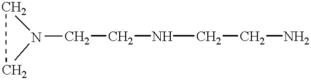

Linear Tetramer

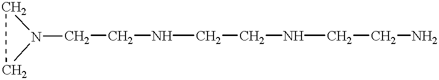

Branched Tetramer

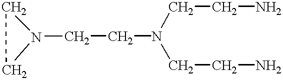

### Psoralens

The furocoumarins of the present invention include psoralen and derivatives, where the substituents can include: alkyl, particularly of from 1 to 3 carbon atoms, e.g., methyl; alkoxy, particularly of from 1 to 3 carbon atoms, e.g., methoxy; and substituted alkyl, of 1 to 6, more usually 1 to 3 carbon atoms having from 1 to 2 heteroatoms, which can be oxy, particularly hydroxy or alkoxy of from 1 to 3 carbon atoms, e.g., hydroxymethyl and methoxymethyl, or amino, including mono- and dialkyl amino having a total of from 1 to 6 carbon atoms, e.g., aminomethyl. There are from 1 to 5, usually 2 to 4 substituents, which are normally at the 4, 5, 8, 4′ and 5′ positions, particularly at the 4′-position. Synthesis of the psoralen compounds of this invention is performed using synthetic schemes well known in the art. See, for example, U.S. Pat. No. 5,578,736 (Wollowitz et al.), U.S. Pat. No. 5,625,079 (Wollowitz et al.) and WO 96/40857 (Hei). UV irradiation can be from 1 minute to 300 minutes.

Representative psoralens are listed in Table 2.

TABLE 2

Representative Psoralen Compounds
5-methoxypsoralen
8-methoxypsoralen (8-MOP)
4,5′,8-trimethylpsoralen (TMP)
4′-hydroxymethyl-4,5′,8-trimethylpsoralen (HMT)
4′-aminomethyl-4,5′,8-trimethylpsoralen (AMT)
4-methylpsoralen
4,4′-dimethylpsoralen
4,5′-dimethylpsoralen
4′,8-dimethylpsoralen
4′-methoxymethyl-4,5′,8-trimethylpsoralen
4,8-dialkyl-4′-bromomethyl-5′-methylpsoralen
5′-(4-amino-2-oxa)butyl-4,4′,8-trimethylpsoralen
4′-(4-amino-2-oxa)butyl-4,5′,8-trimethylpsoralen (S-59)
4′-(4-amino-2-aza)butyl-4-5′,8-trimethylpsoralen
4′-(2-aminoethyl)-4,5′,8-trimethylpsoralen
4′-(5-amino-2-oxa)pentyl-4,5′8-trimethylpsoralen
4′-(5-amino-2-aza)pentyl-4,5′8-trimethylpsoralen
4′-(6-amino-2-aza)hexyl-4,5′8-trimethylpsoralen
4′-(7-amino-2,5-oxa)heptyl-4,5′8-trimethylpsoralen
4′-(12-amino-8-aza-2,5-dioxa)dodecyl-4,5′8-
trimethylpsoralen
4′-(13-amino-8-aza-2,11-dioxa)tridecyl-4,5′8-
trimethylpsoralen
4′-(7-amino-2-aza)heptyl-4,5′5-trimethylpsoralen
4′-(7-amino-2-aza-5-oxa)heptyl-4,5′8-trimethylpsoralen
4′-(9-amino-2,6-diaza)nonyl-4,5′8-trimethylpsoralen
4′-(8-amino-5-aza-2-oxa)octyl-4,5′8-trimethylpsoralen
4′-(9-amino-5-aza-2-oxa)nonyl-4,5′8-trimethylpsoralen
4′-(14-amino-2,6,11-triaza)tetradecyl-4,5′8-
trimethylpsoralen
5′-(6-amino-2-aza)hexyl-4,4′8-trimethylpsoralen
5′-(4-amino-2-oxa)butyl-4,4′8-trimethylpsoralen

### Nucleases

Due to the possibility that disrupted virus particles can re-assemble after pressure treatment, it can be desirable to irreversibly degrade the nucleic acids contained in the virus. Moderately high pressures, e.g., 20,000 psi to 60,000 psi, can disrupt complexes of nucleases and their endogenous inhibitors. The activated nucleases can serve to degrade nucleic acids and thereby enhance irreversible inactivation of viruses.

Representative nucleases include both exonucleases and endonucleases, for example, pancreatic DNase I, exonuclease III (Exo III), restriction endonucleases, RNase A, RNase H.

### EXAMPLES

### Example 1

### Pressure and Ethyleneimine

Bacteriophage MS2 is prepared according to the method of Rogerson et al., Anal. Biochem., 67: 675-678, 1975. The infectivity of the virus suspension is determined by a conventional bilayer technique on a meat-peptone agar with F⁺ strain of Escherichia coli (CA180).

A sample of human blood plasma is inoculated with 10⁸ plaque forming units (pfu) per ml of bacteriophage MS2. The sample is split into four aliquots and are treated as follows:

1) aliquot 1—no treatment;

2) aliquot 2—0.025 M ethyleneimine (aziridine) added and incubated for 10 minutes;

3) aliquot 3—0.025 M ethyleneimine (aziridine) added and pressurized to 30,000 psi for 10 minutes; and

4) aliquot 4—nothing added and pressurized to 30,000 psi for 10 minutes.

All samples are held at a temperature of 25° C. throughout the experiment. After treatment, the plasma is serially diluted, mixed with E. coli and plated on agar. After overnight incubation at 37° C., the plaques on the plates are counted to arrive at the relative reduction of viral titer due to pressurization, the ethyleneimine treatment and the combination of pressurization and ethyleneimine treatment.

It is found that aliquot 3 has a significantly greater reduction in viral titer (as compared to aliquot 1) than the sum of the reductions observed from aliquots 2 and 4, thereby demonstrating a synergistic effect of pressure and ethyleneimine. Similar experiments are carried out with lower concentrations of ethyleneimine and it is found that pressure allows equivalent viral inactivation with lower concentrations of ethyleneimine or with shorter incubation time.

### Example 2

### Pressure Cycling and 1-(2-aminoethyl)aziridine

A sample of human blood plasma is inoculated with 10⁸ plaque forming units (pfu) per ml of bacteriophage MS2. The sample is split into four aliquots and are treated as follows:

1) aliquot 1—no treatment;

2) aliquot 2—0.007 M 1-(2-aminoethyl)aziridine added and incubated for 200 minutes;

3) aliquot 3—0.007 M 1-(2-aminoethyl)aziridine added, pressurized to 80,000 psi for 10 minutes, pressure released over a period of 2 seconds and the pressure process repeated for 20 cycles; and

4) aliquot 4—nothing added, pressurized to 80,000 psi for 10 minutes, pressure released over a period of 2 seconds and the pressure process repeated for 20 cycles.

All samples are held at a temperature of 25° C. throughout the experiment. After treatment, the plasma is serially diluted, mixed with E. coli and plated on agar. After overnight incubation at 37° C., the plaques on the plates are counted to arrive at the relative reduction of viral titer due to pressurization cycling, the 1-(2-aminoethyl)aziridine treatment and the combination of pressurization cycling and 1-(2-aminoethyl)aziridine treatment.

It is found that aliquot 3 has a significantly greater reduction in viral titer (as compared to aliquot 1) than the sum of the reductions observed from aliquots 2 and 4, thereby demonstrating a synergistic effect of pressure cycling and 1-(2-aminoethyl)aziridine treatment. Similar experiments are carried out with lower concentrations of 1-(2-aminoethyl)aziridine and it is found that pressure cycling allows equivalent viral inactivation with lower concentrations of 1-(2-aminoethyl)aziridine or with shorter incubation time.

### Example 3

### Pressure and 4′-hydroxymethyl-4,5′, 8-trimethylpsoralen (HMT)

Feline rhinotrachetis virus, a member of the Herpes family, is added to human blood plasma in an amount that gives a final concentration of approximately 2×10⁷ plaque forming units (pfu) per ml. The infectivity of the virus suspension is determined by duplicate plaque assays on cultured feline cells, Fc3Tg (ATCC CCL 176) with a methylcellulose overlay. The sample is split into four aliquots and are treated as follows:

1) aliquot 1—no treatment;

2) aliquot 2—20 μg/ml 4′-hydroxymethyl-4,5′, 8-trimethylpsoralen (HMT) added and irradiated with longwave UV light (320 to 380 nm) for 10 minutes;

3) aliquot 3—20 μg/ml 4′-hydroxymethyl-4,5′, 8-trimethylpsoralen (HMT) added, pressurized to 30,000 psi for 10 minutes and then irradiated with longwave UV light (320 to 380 nm) for 10 minutes; and

4) aliquot 4—nothing added and pressurized to 30,000 psi for 10 minutes.

All samples are held at a temperature of 25° C. throughout the experiment. After treatment, the plasma is serially diluted, mixed with cultured feline cells and plated on agar. After 72 hours of incubation at 37° C., the plaques on the plates are counted to arrive at the relative reduction of viral titer due to pressurization, the 4′-hydroxymethyl-4,5′, 8-trimethylpsoralen (HMT) treatment and the combination of pressurization and 4′-hydroxymethyl-4,5′, 8-trimethylpsoralen (HMT) treatment.

It is found that aliquot 3 has a significantly greater reduction in viral titer (as compared to aliquot 1) than the sum of the reductions observed from aliquots 2 and 4, thereby demonstrating a synergistic effect of pressure and 4′-hydroxymethyl-4,5′, 8-trimethylpsoralen (HMT). Similar experiments are carried out with lower concentrations of 4′-hydroxymethyl-4,5′, 8-trimethylpsoralen (HMT) and it is found that pressure allows equivalent viral inactivation with lower concentrations of 4′-hydroxymethyl-4,5′, 8-trimethylpsoralen (HMT) or with shorter incubation time.

### Example 4

### Pressure Cycling and 4′-(4-amino-2-oxa)butyl-4,5′, 8-trimethylpsoralen (S-59)

A sample of human blood plasma is inoculated with 2×10⁷ plaque forming units (pfu) per ml of feline rhinotrachetis virus. The sample is split into four aliquots and are treated as follows:

1) aliquot 1—no treatment;

2) aliquot 2—150 μM 4′-(4-amino-2-oxa)butyl-4,5′, 8-trimethylpsoralen (S-59) added and irradiated with longwave UV light (320 to 380 nm) for 10 minutes;

3) aliquot 3—150 μM 4′-(4-amino-2-oxa)butyl-4,5′, 8-trimethylpsoralen (S-59) added, irradiated with longwave UV light (320 to 380 nm) for 10 minutes, pressurized to 90,000 psi for 5 minutes, pressure released over a period of 2 seconds, the pressure process repeated for 24 cycles and then irradiated with longwave UV light (320 to 380 nm) for ten minutes; and

4) aliquot 4—nothing added, pressurized to 90,000 psi for 5 minutes, pressure released over a period of 2 seconds and the pressure process repeated for 24 cycles.

All samples are held at a temperature of 25° C. throughout the experiment. After treatment, the plasma is serially diluted, mixed with cultured feline cells and plated on agar. After 72 hours of incubation at 37° C., the plaques on the plates are counted to arrive at the relative reduction of viral titer due to pressurization cycling, the 4′-(4-amino-2-oxa)butyl-4,5′, 8-trimethylpsoralen (S-59) treatment and the combination of pressurization cycling and 4′-(4-amino-2-oxa)butyl-4,5′, 8-trimethylpsoralen (S-59) treatment.

It is found that aliquot 3 has a significantly greater reduction in viral titer (as compared to aliquot 1) than the sum of the reductions observed from aliquots 2 and 4, thereby demonstrating a synergistic effect of pressure cycling and 4′-(4-amino-2-oxa)butyl-4,5′, 8-trimethylpsoralen trimethylpsoralen (S-59) treatment. Similar experiments are carried out with lower concentrations of 4′-(4-amino-2-oxa)butyl-4,5′, 8-trimethylpsoralen (S-59) and it is found that pressure cycling allows equivalent viral inactivation with lower concentrations of 4′-(4-amino-2-oxa)butyl-4,5′, 8-trimethylpsoralen (S-59) or with shorter incubation time.

### Example 5

### Pressure and RNase

Bacteriophage MS2, an RNA phage, is prepared according to the method of Rogerson et al., Anal. Biochem., 67: 675-678, 1975. The infectivity of the virus suspension is determined by a conventional bilayer technique on a meat-peptone agar with F⁺strain of Escherichia coli (CA180).

A sample of human blood plasma is inoculated with 10⁸ plaque forming units (pfu) per ml of bacteriophage MS2. The sample is split into four aliquots and are treated as follows:

1) aliquot 1—no treatment;

2) aliquot 2—10 μg/ml RNase A added and incubated for 30 minutes;

3) aliquot 3—10 μg/ml RNase A added and pressurized to 25,000 psi for 20 minutes; and

4) aliquot 4—nothing added and pressurized to 25,000 psi for 10 minutes.

All samples are held at a temperature of 37° C. throughout the experiment. After treatment, the plasma is serially diluted, mixed with E. coli and plated on agar. After overnight incubation at 37° C., the plaques on the plates are counted to arrive at the relative reduction of viral titer due to pressurization, the RNase treatment and the combination of pressurization and RNase treatment.

It is found that aliquot 3 has a significantly greater reduction in viral titer (as compared to aliquot 1) than the sum of the reductions observed from aliquots 2 and 4, thereby demonstrating a synergistic effect of pressure and RNase. Similar experiments are carried out with lower concentrations of RNase and it is found that pressure allows equivalent viral inactivation with lower concentrations of RNase or with shorter incubation time.

### Example 6

### Pressure Cycling and DNase

A sample of human blood plasma is inoculated with 10⁸ plaque forming units (pfu) per ml of SV 40, a DNA virus. The sample is split into four aliquots and are treated as follows:

1) aliquot 1—no treatment;

2) aliquot 2—20 μg/ml DNase I added and incubated for 250 minutes;

3) aliquot 3—20 μg/ml DNase I added, pressurized to 90,000 psi for 10 minutes, pressure released over a period of 2 seconds and the pressure process repeated for 25 cycles; and

4) aliquot 4—nothing added, pressurized to 90,000 psi for 10 minutes, pressure released over a period of 2 seconds and the pressure process repeated for 25 cycles.

All samples are held at a temperature of 37° C. throughout the experiment. After treatment, the plasma is serially diluted, mixed with primate cells and cultured. After 72 hours of incubation at 37° C., the plaques on the plates are counted to arrive at the relative reduction of viral titer due to pressurization cycling, DNase treatment and the combination of pressurization cycling and DNase treatment.

It is found that aliquot 3 has a significantly greater reduction in viral titer (as compared to aliquot 1) than the sum of the reductions observed from aliquots 2 and 4, thereby demonstrating a synergistic effect of pressure cycling and DNase treatment. Similar experiments are carried out with lower concentrations of DNase and it is found that pressure cycling allows equivalent viral inactivation with lower concentrations of DNase or with shorter incubation time.

It will be understood by those skilled in the art that any viral inactivating compound, e.g., the pH-activated ALE (anchor-linker-effector) compound, S-303, developed by Cerus Corporation, may be used with pressure exposure in the method of the present invention.

While the invention has been described in connection with what is presently considered to be the most practical and preferred embodiments, it is to be understood that the invention is not limited to the disclosed embodiments, but on the contrary is intended to cover various modifications and equivalent arrangements included within the spirit and scope of the appended claims.

Thus, it is to be understood that variations in the present invention can be made without departing from the novel aspects of this invention as defined in the claims. All patents and articles cited herein are hereby incorporated by reference in their entirety and relied upon.

What is claimed is:

1. A method of inactivating viruses in a sample, comprising the steps of:
a) adding an inactivating chemical to the sample;
b) exposing the sample to an elevated pressure;
c) releasing the pressure; and
d) recovering the sample.

2. The method of claim 1, wherein the inactivating chemical is selected from the group consisting of ethyleneimine, ethyleneimine oligomers, DNase and RNase.

3. The method of claim 1, wherein the sample is selected from the group consisting of human blood plasma, human blood plasma derivatives and recombinant human blood plasma derivatives.

4. The method of claim 1, wherein the elevated pressure is in the range of about 5,000 psi to about 150,000 psi.

5. A method of inactivating viruses in a sample, comprising the steps of:
a) adding an inactivating chemical to the sample;
b) exposing the sample to an elevated pressure;
c) releasing the pressure;
d) irradiating the sample with UV light;
e) recovering the sample.

6. The method of claim 5, wherein the inactivating chemical is a psoralen.

7. The method of claim 5, wherein the sample is selected from the group consisting of human blood plasma, human blood plasma derivatives and recombinant human blood plasma derivatives.

8. The method of claim 5, wherein the elevated pressure is in the range of about 5,000 psi to about 150,000 psi.

9. The method of claim 5, wherein the sample is irradiated with UV light from 1 to 300 minutes.

10. A method of inactivating viruses in a sample, comprising the steps of:
a) adding an inactivating chemical to the sample;
b) exposing the sample to an elevated pressure;
c) releasing the pressure;
d) re-exposing the sample to an elevated pressure;
e) releasing the pressure; and
f) recovering the sample.

11. The method of claim 10, wherein the inactivating chemical is selected from the group consisting of ethyleneimine, ethyleneimine oligomers, DNase and RNase.

12. The method of claim 10, wherein the sample is selected from the group consisting of human blood plasma, human blood plasma derivatives and recombinant human blood plasma derivatives.

13. The method of claim 10, wherein the pressure is in the range of about 5,000 psi to about 150,000 psi.

14. The method of claim 10, wherein steps d) and e) are repeated between 2 and 1000 times.

15. A method of inactivating viruses in a sample, comprising the steps of:
a) adding an inactivating chemical to the sample;
b) exposing the sample to an elevated pressure;
c) releasing the pressure;
d) re-exposing the sample to an elevated pressure;
e) releasing the pressure;
f) irradiating the sample with UV light; and
g) recovering the sample.

16. The method of claim 15, wherein the inactivating chemical is a psoralen.

17. The method of claim 15, wherein the sample is selected from the group consisting of human blood plasma, human blood plasma derivatives and recombinant human blood plasma derivatives.

18. The method of claim 15, wherein the pressure is in the range of about 5,000 psi to about 150,000 psi.

19. The method of claim 15, wherein steps d) and e) are repeated between 2 and 1000 times.

20. The method of claim 15, wherein the sample is irradiated with UV light from 1 to 300 minutes.
